(19) United States
(12) Patent Application Publication
(10) Pub. No.: US 2006/0098255 A1
(43) Pub. Date: May 11, 2006

(54) Image-processing method, image-processing device, and imaging device

(75) Inventor: Manabu Hyodo, Asaka-shi (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/265,080

(22) Filed: Nov. 3, 2005

(30) Foreign Application Priority Data
Nov. 5, 2004 (JP) 2004-322781

(51) Int. Cl. G03F 3/08

(52) U.S. Cl. 358/521

(57) ABSTRACT

The present invention provides an image-processing method of synthesizing an high-sensitivity image having a narrow dynamic range and an low-sensitivity image having a wide dynamic range to create an image having a wide dynamic range, the image-processing method comprising: a first gradation-conversion step of applying a gradation conversion to each of a high-sensitivity image signal representing the high-sensitivity image and a low-sensitivity image signal representing the low-sensitivity image; an addition step of adding the gradation-converted high-sensitivity image signal and the gradation-converted low-sensitivity image signal; and a second gradation-conversion step of further applying a gradation conversion, to the added image signal, that corresponds to a gradation property selected from a plurality of gradation properties.

### BACKGROUND OF THE INVENTION

1. Field of the Invention

The present invention relates to image-processing methods, image-processing devices, and imaging devices, and particularly to a technology for creating a wide D-range image, by synthesizing a high-sensitivity image, having a narrow dynamic range (D-range), and a low-sensitivity image, having a wide D-range, that have concurrently been picked up.

2. Description of the Related Art

To date, in the case where a high-sensitivity image and a low-sensitivity image are synthesized to create a wide D-range image, the high-sensitivity image and the low-sensitivity image have been each gamma-corrected, the gamma corrected high-sensitivity and low-sensitivity images have been each multiplied by gain and then added up (Japanese Patent Application Laid-Open No. 2004-221928).

A gamma-correction circuit for gamma-correcting the high-sensitivity image and the low-sensitivity image and a device for outputting gain coefficients by which the gamma-corrected high-sensitivity and the low-sensitivity images are multiplied are configured of four look-up tables (LUT) so that the continuity (smoothness) of gradations of the synthesized wide D-range image is realized; accordingly, the synthesized wide D-range image has smooth gradation properties without any inflection point.

### SUMMARY OF THE INVENTION

Meanwhile, it may be required to change the gradations of an image; however, in Japanese Patent Application Laid-Open No. 2004-221928, there is no description on a technology for changing the entire gradations of a synthesized wide D-range image. In addition, in the case where a high-sensitivity image and a low-sensitivity image are synthesized according to the image-processing method described in Japanese Patent Application Laid-Open No. 2004-221928, in order to change the entire gradations of a synthesized wide D-range image, four LUTs (two gamma-correction LUTs and two gain-coefficient-output LUTs) are required to be adjusted; therefore, there is problems in that not only a hardware load is weighted (a large-capacity memory is required), but also a gradation-design load is weighted.

The present invention has been implemented in consideration of the foregoing situations; it is an object to provide an image-processing method, an image-processing device, and an imaging device that enable to simply change without weighting a hardware load and a gradation-design load the entire gradations of a wide D-range image created by synthesizing a high-sensitivity image and a low-sensitivity image, and to create a wide D-range image having gradation properties in accordance with an image-pickup mode.

In order to achieve the foregoing object, the present invention related to a first aspect is characterized in that an image-processing method of synthesizing an high-sensitivity image having a narrow dynamic range and an low-sensitivity image having a wide dynamic range to create an image having a wide dynamic range includes a first gradation-conversion step of applying a gradation conversion to each of a high-sensitivity image signal representing the high-sensitivity image and a low-sensitivity image signal representing the low-sensitivity image, an addition step of adding the gradation-converted high-sensitivity image signal and the gradation-converted low-sensitivity image signal, and a second gradation-conversion step of further applying a gradation conversion, to the added image signal, that corresponds to a gradation property selected from a plurality of gradation properties.

In the first place, the first gradation-conversion step applies a gradation conversion to each of a high-sensitivity image signal and a low-sensitivity image signal. The gradation conversion in this situation is applied to the high-sensitivity image signal and the low-sensitivity image signal in such a way that an added image signal at the following stage has a continuously (smoothly) changing gradation. Thereafter, the second gradation-conversion step further applies a gradation conversion to an image signal (i.e., a synthesized image signal) obtained by adding the gradation-converted high-sensitivity and low-sensitivity image signals. In this situation, the second gradation-conversion step that is independent from the first gradation-conversion step and applies a gradation conversion to the synthesized image signal implements a required gradation conversion; therefore, the entire gradations of a wide dynamic-range image can simply be changed.

In a second aspect, the image-processing method of the first aspect is characterized in that gradation-conversion step implements a gradation conversion that varies in accordance with the width of a dynamic range. Accordingly, the dynamic range of a wide dynamic-range image can appropriately be changed.

In a third aspect, the image-processing method of the first aspect or the second aspect is characterized in that the second gradation-conversion step implements a gradation conversion, for changing a tone of an image represented by the added image signal into one of tones over a range from soft tone to hard tone, that corresponds to a gradation property, among a plurality of gradation properties, selected in accordance with an image-pickup mode. Accordingly, the entire gradations of a wide dynamic-range image can be changed in accordance with an image-pickup mode, whereby image creation suitable to each image-pickup mode can be implemented.

The present invention related to a fourth aspect is characterized in that an image-processing device for synthesizing an high-sensitivity image having a narrow dynamic range and an low-sensitivity image having a wide dynamic range to create an image having a wide dynamic range includes a first gradation-conversion device that applies a gradation conversion to a high-sensitivity image signal representing the high-sensitivity image, a second gradation-conversion device that applies a gradation conversion to a low-sensitivity image signal representing the low-sensitivity image, an addition device that adds the high-sensitivity image signal and the low-sensitivity image signal that have been gradation-converted by the first gradation-conversion device and the second gradation-conversion device, respectively, and a third gradation-conversion device that applies a gradation conversion, to the added image signal, that corresponds to a gradation property selected from a plurality of gradation properties.

In a fifth aspect, the image-processing method of the fourth aspect is characterized in that the first gradation-conversion device and the second gradation-conversion device each have a plurality of gradation-conversion look-up tables each corresponding to width of a dynamic range, and by applying respective gradation conversions to the high-sensitivity image signal and the low-sensitivity image signal, based on respective gradation-conversion look-up tables selected from the plurality of gradation-conversion look-up tables.

In a aspect six, the image-processing device of the fourth aspect or the fifth aspect is characterized in that the third gradation-conversion device have a plurality of gradation-conversion look-up tables for converting a tone of an image represented by the added image signal into a plurality of tones within a range from soft tone to hard tone, and by applying a gradation conversion to the added image signal, based on a gradation-conversion look-up table selected from the plurality of gradation-conversion look-up tables.

The imaging device related to a seventh aspect is characterized by including an image-pickup device that can pick up each of a high-sensitivity image signal and a low-sensitivity image signal, a first gradation-conversion device that applies a gradation conversion to a high-sensitivity image signal picked up through the image-pickup device, a second gradation-conversion device that applies a gradation conversion to a low-sensitivity image signal picked up through the image-pickup device, an addition device that adds the high-sensitivity image signal and the low-sensitivity image signal that have been gradation-converted by the first gradation-conversion device and the second gradation-conversion device, respectively, a third gradation-conversion device that applies a gradation conversion, to the added image signal, that corresponds to a gradation property selected from a plurality of gradation properties, an image-pickup mode selection device that selects an image-pickup mode, and a controlling device that makes a gradation property to be selected based on an image-pickup mode that has been selected by the image-pickup mode selection device, the gradation property being utilized in the third gradation-conversion device.

Accordingly, the entire gradations of a wide dynamic-range image can be changed in accordance with an image-pickup mode selected through an image-pickup mode selection device, whereby image creation suitable to each image-pickup mode can be implemented. In this situation, as image-pickup modes, a landscape mode, a portrait mode, and the like are conceivable, in addition to a mode for selecting softness or hardness of a tone.

In a eighth aspect, the imaging device of the seventh aspect is characterized in that the first gradation-conversion device and the second gradation-conversion device each have a plurality of gradation-conversion look-up tables each corresponding to width of a dynamic range, and by applying respective gradation conversions to the high-sensitivity image signal and the low-sensitivity image signal, based on respective gradation-conversion look-up tables selected from the plurality of gradation-conversion look-up tables.

In a ninth aspect, the imaging device of the seventh aspect or the eighth aspect is characterized in that the third gradation-conversion device applies a gradation conversion to the added image signal, based on a gradation-conversion look-up table selected from a plurality of gradation-conversion look-up tables for converting a tone of an image represented by the added image signal into a plurality of tones within a range from soft tone to hard tone.

According to the present invention, after a high-sensitivity image and a low-sensitivity image are synthesized to create a wide dynamic-range image, the wide dynamic-range image is further gradation-converted; it is possible to simply change the entire gradations of a wide dynamic-range image, without weighting a hardware load and a gradation-design load.

### BRIEF DESCRIPTION OF THE DRAWINGS

FIG. 1 is a schematic plan view illustrating an example of a CCD utilized in an imaging device according to the present invention;

FIG. 2 is a graph representing the photoelectric-conversion properties of a main pixel and a subordinate pixel of the CCD;

FIG. 3 is a block diagram illustrating an embodiment of an imaging device according to the present invention;

FIG. 4 illustrates a menu screen for manually selecting a D-range and hardness or softness of a tone (image-pickup mode);

FIG. 5 is a detailed block diagram illustrating a circuitry configuration of the signal processing unit illustrated in FIG. 3;

FIG. 6 represents respective signal levels for image data synthesized in accordance with respective D-ranges;

FIG. 7 represents respective signal levels for image data obtained by further applying a gradation conversion to image data corresponding to six D-ranges; and

FIG. 8 is a graph representing respective output-versus-input properties for three gradation-conversion LUTs.

### DETAILED DESCRIPTION OF THE PREFERRED EMBODIMENTS

A preferred embodiment of an image-processing method, an image-processing device, and an imaging device according to the present invention will be explained in detail below.

[Structure of Imaging Element]

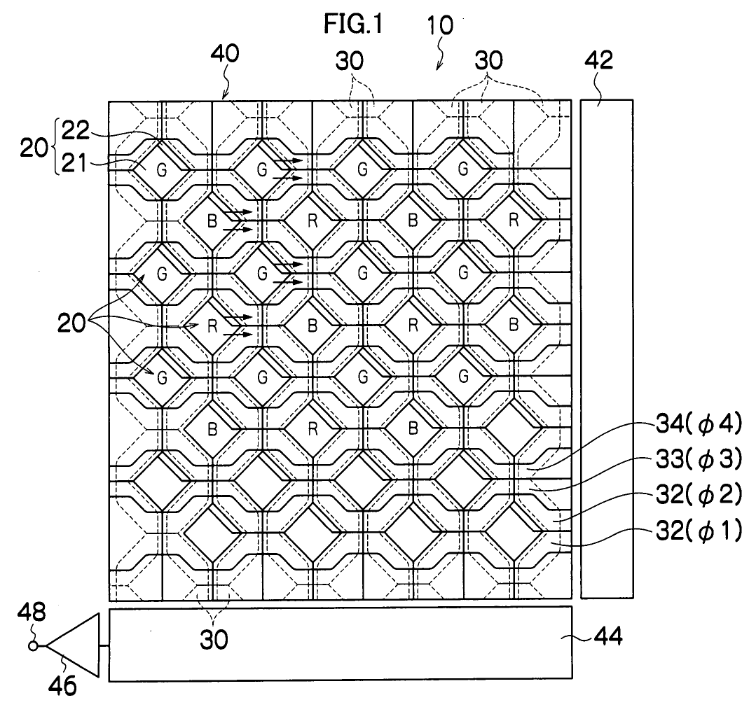

In the first place, the structure of an imaging element applied to an imaging device according to the present invention will be explained. FIG. 1 is a schematic plan view of a CCD solid-state image pickup device (referred to as a CCD, hereinafter) utilized in an imaging device according to the present invention.

As illustrated in FIG. 1, a CCD 10 is a two-dimensional imaging device (image sensor) in which a great number of light-sensitive cells 20 are arranged at a constant alignment period, in the horizontal direction (row direction) and in the vertical direction (column direction). The illustrated structure is pixel alignment referred to as honeycomb alignment; the light-sensitive cells 20 are arranged in such a way that the geometric center points of the cells are aligned being shifted every 2 cells by half a pixel pitch (½ pitch), in the row direction and in the column direction. In other words, the imaging element has a structure in which, with a relationship between the neighboring rows (or the columns) of the light-sensitive cells 20, the cell alignment of the one row (or column) is arranged being relatively shifted by approximately half of the row-directional (or column-directional) alignment space, with respect to the cell alignment of the other row (or column).

Each of the light-sensitive cells 20 includes two photo-diode areas 21 and 22 that are different in sensitivity. A first photo-diode area 21 has a relatively wide area, and configures a high-sensitivity main photosensitive portion (referred to as a “main pixel”, hereinafter). A second photo-diode area 22 has a relatively narrow area, and configures a low-sensitivity subordinate photosensitive portion (referred to as a “subordinate pixel”, hereinafter).

With regard to each light-sensitive cell 20, the respective same-colored color filters are disposed on the main pixel 21 and the subordinate pixel 22. In other words, a primary-color filter having one color out of R, G, and B is assigned to each light-sensitive cell 20. As illustrated in FIG. 1, with regard to the horizontal direction, the row GGGG, the row BRBR, the row GGGG, and RBRB are sequentially aligned in that order. In addition, with regard to the column direction, the column GGGG, the column BRBR, the column GGGG, and the column RBRB configure a circularly recurrent alignment pattern.

A vertical transfer path (VCCD) 30 is formed at the right side of the light-sensitive cell 20. The vertical transfer path 30 meanders, in a zigzag manner, in the vicinity of each corresponding column of the light-sensitive cells 20, while avoiding the light-sensitive cell 20, and extends in the vertical direction.

Transfer electrodes 31, 32,33, and 34 necessary for four-phase drive (φ1, φ2, φ3, and φ4) are arranged on the vertical transfer path 30. The transfer electrodes 31 through 34 are provided in such a way as to meander in the vicinity of each corresponding row of the light-sensitive cells 20, while avoiding the apertures for the light-sensitive cells 20, and to extend in the horizontal direction in FIG. 1. For example, in the case where the transfer electrodes are formed of two-layer polysilicon, a first transfer electrode 31 and a third transfer electrode 33, to which a pulse voltage having a phase φ1 and a pulse voltage having a phase φ3 are applied, respectively, are formed of a first-layer polysilicon layer; a second transfer electrode 32 and a fourth transfer electrode 34, to which a pulse voltage having a phase φ2 and a pulse voltage having a phase φ4 are applied, respectively, are formed of a second-layer polysilicon layer.

In FIG. 1, a VCCD driving circuit 42 for applying a voltage to the transfer electrodes 31 through 34 is arranged at the right side of an image pickup area 40 in which the light-sensitive cells 20 are aligned. In addition, a horizontal transfer path (HCCD) 44 for transferring in the horizontal direction signal charges forwarded from the vertical transfer path 30 is provided beneath the image pickup area 40 (at the bottom-end side of the vertical transfer path 30).

The horizontal transfer path 44 is configured of a two-phase-drive transfer CCD; the last stage of the horizontal transfer path 44 (the leftmost stage in FIG. 1) is connected to an output unit 46. The output unit 46 including an output amplifier detects inputted signal charges, and outputs the resultant signal voltage to an output terminal 48. Accordingly, a signal obtained through photoelectric conversion by each of the light-sensitive cells 20 is outputted as a point-sequential signal train.

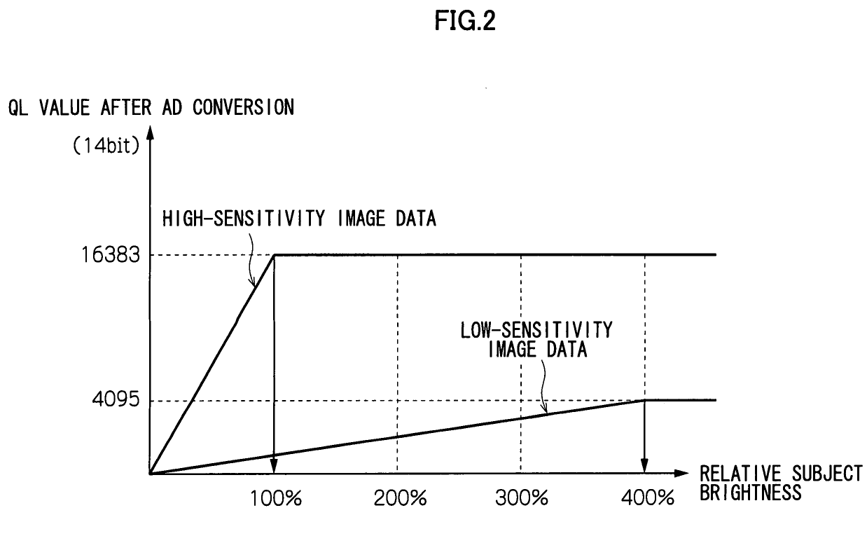

FIG. 2 is a graph representing the photoelectric-conversion properties of the main pixel 21 and the subordinate pixel 22; the abscissa represents the relative subject brightness, and the ordinate represents the after-A/D-conversion image data value (QL value). In the present embodiment, 14-bit data is represented; however, the number of bits is not limited to 14. In addition, the relative subject brightness is defined in such a way that the subject brightness with which high-sensitivity image data is saturated has a level of 100%.

The output of the main pixel 21 gradually increases in proportion to the relative subject brightness, and reaches a saturation value (QL value=163834), when the relative subject brightness is 100% (the D-range is 100%). Thereafter, even though the relative subject brightness increases, the output of the main pixel 21 stays constant.

Meanwhile, the sensitivity ratio and the saturation ratio of the subordinate pixel 22 of the present embodiment to the main pixel 21 is 1/16 and ¼, respectively; the output of the subordinate pixel 22 is saturated at the QL value of 4095, when the relative subject brightness is 400%.

Accordingly, by combining the main pixel 21 with the subordinate pixel 22, the dynamic range of the imaging element can be expanded up to four times as wide as that of the structure formed of the main pixel 21 only.

In addition, in the CCD 10 of the present embodiment, the light-sensitive cell 20 includes two photo-diode areas 21 and 22 that configure the main pixel 21 and the subordinate pixel 22, respectively; however, the present invention is not limited to that foregoing embodiment. The imaging element may be configured in such a way that the main pixels and the subordinate pixels are each aligned in the same space.

[Configuration Example of Imaging Element]

Next, an imaging device equipped with the foregoing CCD 10 for wide dynamic-range image pickup will be explained.

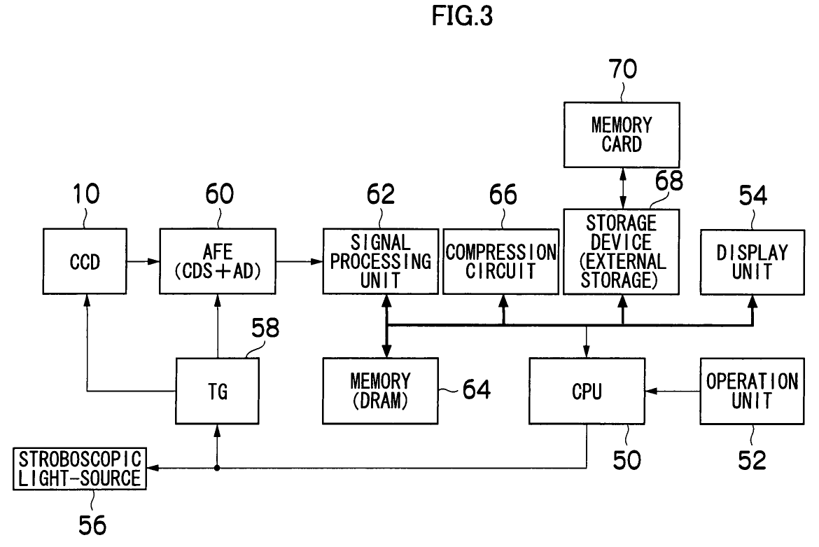

FIG. 3 is a block diagram illustrating an embodiment of an imaging device according to the present invention. The entire operation of the imaging device 10 is integrally controlled by a central processing unit (CPU) 50.

The imaging device 10 includes an operation unit 52. The operation unit 52 includes a shutter button, a mode switch lever for switching the image-pickup mode and the playback mode, a mode dial for selecting a image-pickup mode (a continuous pickup mode, an automatic pickup mode, a manual pickup mode, a portrait mode, a landscape mode, and a night scene mode), a menu button for making a display unit 54 display the menu screen, a multi-function cross-shape key for selecting a desired item from the menu screen, an OK button for fixing a selected item or instructing to put processing into effect, and a BACK button for deleting an desired subject such as a selected item, canceling an instruction item, or inputting an instruction for reinstating the central processing unit to an immediately previous operational condition. The output signal of the operation unit 52 is inputted to the CPU 50.

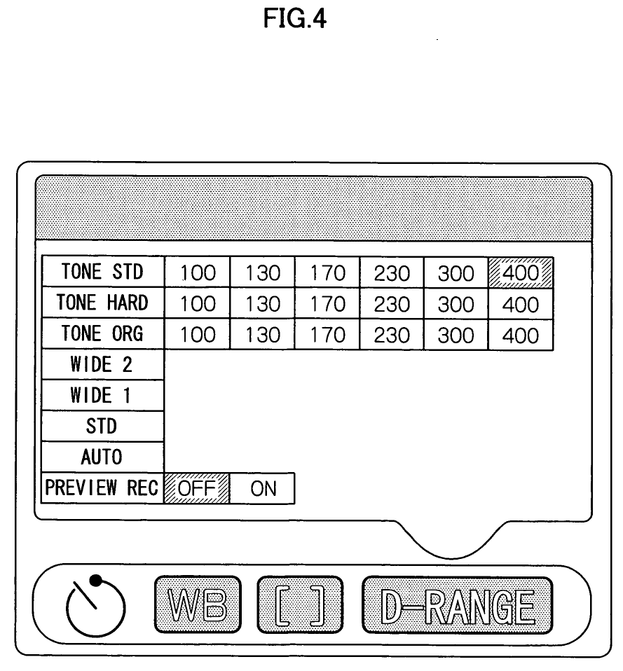

FIG. 4 illustrates a menu screen for manually selecting a D-range and hardness or softness of a tone (image-pickup mode). In other words, by operating the menu button and the cross-shape key of the operation unit 52 to make the display unit 54 display the menu screen illustrated in FIG. 4, and, while the cross-shape key being operated on the menu screen, a D-range (100%, 130%, 170%, 230%, 300%, and 400%) and a image-pickup mode (Tone STD, Tone HARD, and Tone ORG) are selected. Thereafter, pressing the OK button fixes the selected items, which are utilized in implementing image processing described later.

In addition, Tone STD, Tone HARD, and Tone ORG denote a standard mode, a hard tone mode, and a soft tone mode, respectively.

Returning to FIG. 3, the imaging device 10 includes a stroboscopic light-source 56 for irradiating stroboscopic light onto a photographic subject and a timing generator 58 for generating various clock pulses and the like. Clock pulses and the like generated by the timing generator 58 are applied to the CCD 10 and an analogue front end (AFE) 60.

A signal accumulated in a photo sensor for main pixels (main-pixel-frame signal) and a signal accumulated in a photo sensor for subordinate pixels (subordinate-pixel-frame signal) are sequentially read out, as voltage signals, from the CCD 10, based on the clock pulses generated by the timing generator 58. The main-pixel-frame CCD signal and the subordinate-pixel-frame CCD signal are applied to the AFE 60.

The AFE 60 has a CDS circuit and an A/D converter; the CDS circuit applies correlation double sampling processing to the CCD signals inputted based on CDS pulses forwarded from the timing generator 58; and the A/D converter converts pixel by pixel the signal processed by the CDS circuit into digital image data (high-sensitivity image data and low-sensitivity image data).

The high-sensitivity image data for the main pixel frame and the low-sensitivity image data for the subordinate pixel frame (point-sequential R, G, and B signals) are temporarily stored in a memory 64, through a signal processing unit 62. The high-sensitivity image data and the low-sensitivity image data are read out from the memory 64, and inputted to the signal processing unit 62, where predetermined blemish compensation processing is applied to the high-sensitivity image data and the low-sensitivity image data. The high-sensitivity image data and the low-sensitivity image data, to both of which the blemish compensation processing has been applied, are outputted to the memory 64, and then again stored therein.

The high-sensitivity image data and the low-sensitivity image data are again read out from the memory 64, and inputted to the signal processing unit 62, where required processing including processing of synthesizing the high-sensitivity image data and the low-sensitivity image data is applied to the high-sensitivity image data and the low-sensitivity image data. In addition, the detail of image processing in the image processing unit 62 will be described later.

The image data (a luminance signal Y and color-difference signals Cr and Cb) processed in the signal processing unit 62 is again stored in the memory 64. The luminance signal Y and color-difference signals Cr and Cb stored in the memory 64 is forwarded to a compression circuit 66, where the luminance signal Y and color-difference signals Cr and Cb are compressed in accordance with a predetermined compression format (e.g., the JPEG system). The compressed image data is stored in a memory card 70, through a storage device 68.

In addition, on the display unit 54, a video picture (a through-movie image) is displayed in the image-pickup standby mode; an image stored in the memory card 70 is displayed in the playback mode.

[Detailed Configuration Example of the Signal Processing Unit 62]

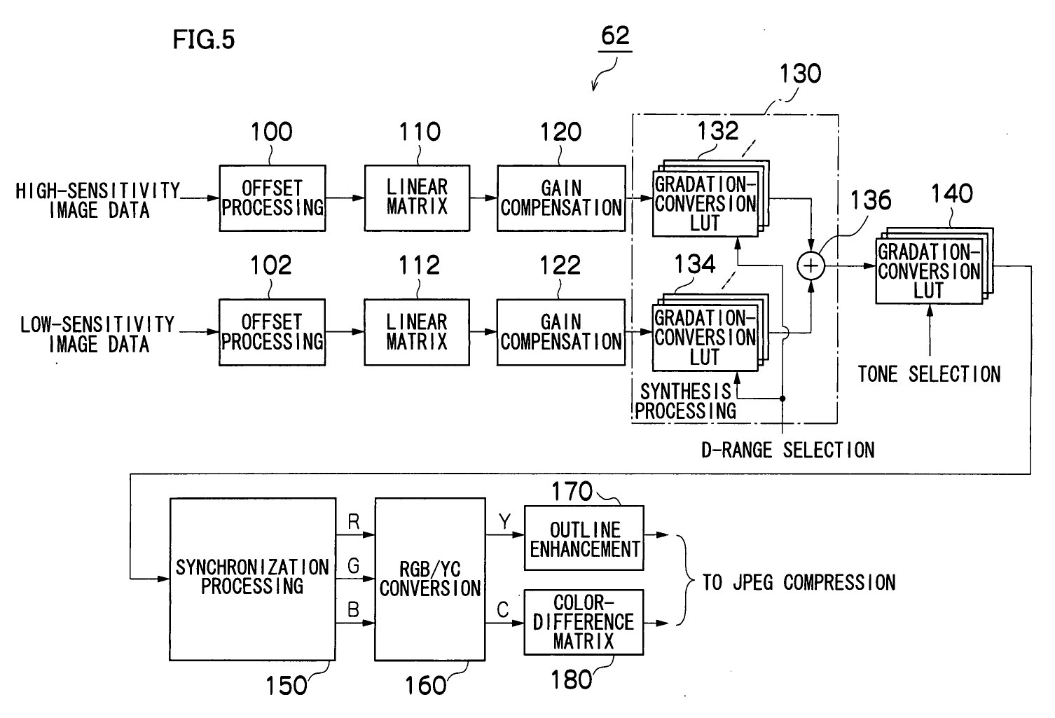

FIG. 5 is a detailed block diagram illustrating a circuitry configuration of the signal processing unit 62 illustrated in FIG. 3.

As described above, the high-sensitivity image data and the low-sensitivity image data that have temporarily been stored in the memory 64 are forwarded to offset processing circuits 100 and 102, in the signal processing unit 62, respectively. Offset processing is applied to the high-sensitivity image data and the low-sensitivity image data, in the offset processing circuits 100 and 102, respectively. High-sensitivity RAW image data and low-sensitivity RAW image data outputted from the offset processing circuits 100 and 102, respectively, are outputted to linear matrix circuits 110 and 112, where color-tone compensation processing for compensating the spectral characteristics of the CCD 10 is applied to the high-sensitivity RAW image data and the low-sensitivity RAW image data. In addition, the high-sensitivity RAW image data and the low-sensitivity RAW image data can also be stored in the memory card 70.

The high-sensitivity image data and the low-sensitivity image data outputted from the linear matrix circuits 110 and 112 are outputted to gain compensation circuits 120 and 122, respectively. By multiplying the R, G, and B image data signals by respective white-balance-adjustment gain values, the gain compensation circuits 120 and 122 implement white-balance adjustment. The high-sensitivity image data and the low-sensitivity image data outputted from the gain compensation circuits 120 and 122 are each outputted to a synthesis processing circuit 130.

The synthesis processing circuit 130 is configured mainly of a gradation-conversion LUTs 132 for the high-sensitivity image data, and a gradation-conversion LUTs 134 for the low-sensitivity image data, and an adder 136.

As illustrated in FIG. 4, the gradation-conversion LUTs 132 and the gradation-conversion LUTs 134 each include six gradation-conversion LUTs corresponding to six D-ranges (100%, 130%, 170%, 230%, 300%, and 400%); a corresponding gradation-conversion LUT is selected among the six gradation-conversion LUTs, based on a D-range selection signal designated by the CPU 50. In addition, the D-range selection signal is outputted from the CPU 50, in accordance with the D-range selected through the menu screen in FIG. 4.

The high-sensitivity image data and the low-sensitivity image data inputted to the synthesis processing circuit 130 are each gradation-converted through the gradation-conversion LUTs selected, among the gradation-conversion LUTs 132 and the gradation-conversion LUTs 134, based on the D-range selection signal, and are outputted to the adder 136.

The adder 136 antilog-synthesizes (adds up) the high-sensitivity image data and the low-sensitivity image data that have been gradation-converted by the gradation-conversion LUTs 132 and 134, respectively, and outputs the result to a following-stage gradation-conversion LUT 140.

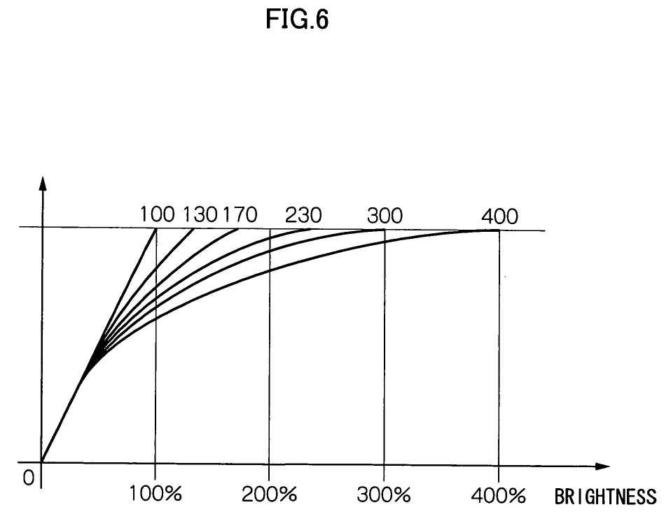

FIG. 6 represents respective levels of the image data signals that have been synthesized by the synthesis processing circuit 130, in accordance with respective D-ranges.

As represented in FIG. 6, the image data signals are synthesized in such a way that the respective maximal levels of the image data signals that have been synthesized in accordance with the D-ranges coincide and the signal levels vary smoothly over the range from 0 to the maximal brightness values of the respective D-ranges. In other words, the foregoing gradation-conversion LUTs 132 and 134 implement gradation-conversion in such a-way that the synthesis results represented in FIG. 6 are obtained.

In addition, in the present embodiment, in the case where the D-range is 100%, only the high-sensitivity image data is utilized, without synthesizing the high-sensitivity image data and the low-sensitivity image data, and gradation-conversion is not applied to the high-sensitivity image data. Accordingly, the gradation-conversion LUTs 132 and 134 are configured of five gradation-conversion LUTs corresponding to five D-ranges other than the D-range of 100%.

In contrast, the gradation-conversion LUTs 140 is configured of, for example, three gradation-conversion LUTs; a corresponding gradation-conversion LUT is selected among the three gradation-conversion LUTs, based on a tone selection signal designated by the CPU 50. The tone selection signal is outputted from the CPU 50, in accordance with the image-pickup mode (Tone STD, Tone HARD, and Tone ORG) selected through the menu screen in FIG. 4.

The synthesized image data outputted from the adder 136 in the synthesis processing unit 130 is forwarded to the gradation-conversion LUT 140, where the synthesized image data is gradation-converted through the gradation-conversion LUT selected based on the tone selection signal

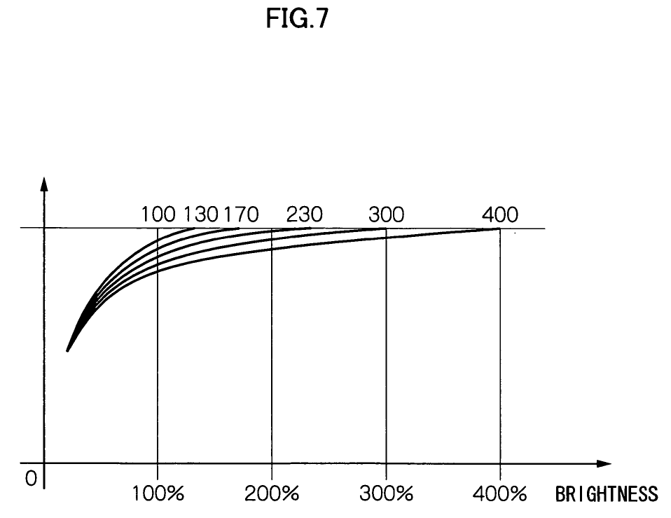

FIG. 7 represents levels of image data signals gradation-converted through the three respective gradation-conversion LUTs 140; levels of six image data signals each having different D-ranges are represented.

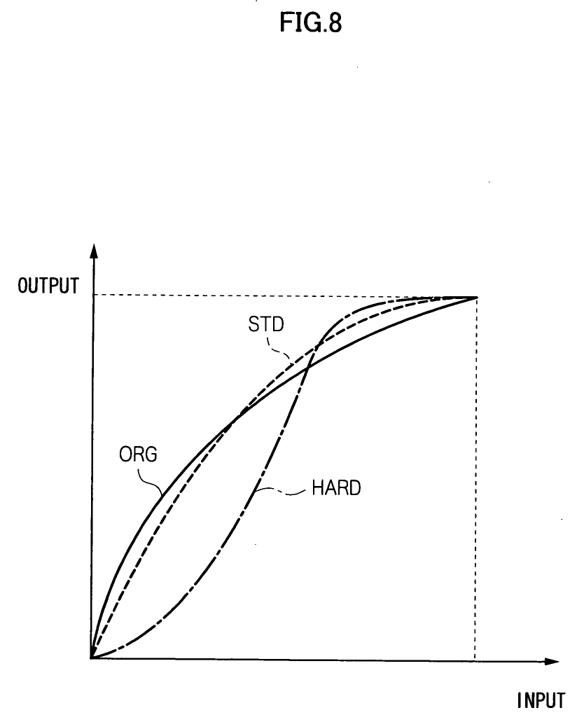

FIG. 8 is a graph representing the respective input-output characteristics of the three gradation-conversion LUTs 140; tone curves for Tone STD, Tone HARD, and Tone ORG are represented. As described above, when Tone STD is selected, gradation-conversion resulting in a standard color tone is implemented; Tone HARD, a hard color tone; and Tone ORG, a soft color tone.

The gradation-conversion LUT 140 makes it possible to readily change the entire gradations of a synthesized wide D-range image.

The wide D-range R, G, and B point-sequential image data signals the respective entire gradations of which have been changed through the gradation-conversion LUTs 140 are forwarded to a synchronization processing circuit 150. After implementing processing of compensating time differences, among R, G, and B signals, due to alignment of color filters for a single-plate CCD, thereby converting the R, G, and B signals into synchronized R, G, and B signals, the synchronization processing circuit 150 outputs the synchronized R, G, and B signals to a RGB/YC conversion circuit 160.

The RGB/YC conversion circuit 160 converts the R, G, and B signals into a luminance signal Y and color-difference signals Cr and Cb, and then outputs the luminance signal Y and the color-difference signals Cr and Cb to an outline enhancement circuit 170 and a color-difference matrix circuit 180, respectively. The outline enhancement circuit 170 implements processing of enhancing portions, of the luminance signal Y, corresponding to outlines (portions in which luminance changes significantly); the color-difference matrix circuit 180 applies a required matrix conversion to the color-difference signals Cr and Cb, thereby realizing good color reproducibility.

The luminance signal Y and the color-difference signals Cr and Cb that have been outline-enhanced and color matrix-converted, as described above, respectively, are temporarily stored in the memory 64, compressed by the compression circuit 66, in accordance with the JPEG system, and then stored in the memory card 70, through the storage device 68.

In addition, after, prior to being stored in the memory card 70, being displayed on the display unit 54, the wide D-range image may be stored by confirming the image and pressing the OK button, or synthesis of the wide D-range image or changing the entire gradations may be implemented again, by pressing the BACK button to change the selection for the D-range or the image-pickup mode.

Moreover, in the present embodiment, selection of the D-range is manually implemented; however, the D-range may automatically be selected based on a picked up image.

For example, by dividing low-sensitivity image data, for G, corresponding to one image into 8 by 8 areas and computing the average value for each divided area, the maximal value, among the respective average values computed for the 64 divided areas, is obtained.

As represented in FIG. 2, given that, if the low-sensitivity image data is 4095, the D-range is 400%, the required D-range (Y %) is given by the following equation, by letting X denote the maximal value obtained as described above:
Y=(X/4095)×400(%) (1)

Decision is made to select one out of the D-ranges 100%, 130%, 170%, 230%, 300%, and 400%, based on the D-range (Y %) obtained through Equation (1) described above.

Still moreover, an image pickup mode is selected on the menu screen, among Tone STD, Tone HARD, and Tone ORG; however, the present invention is not limited to the present embodiment. Tone STD, Tone HARD, or Tone ORG may be selected in accordance with the image pickup mode (a continuous pickup mode, an automatic pickup mode, a manual pickup mode, a portrait mode, a landscape mode, and a night scene mode) selected through the mode dial. For example, in the case where the landscape mode is selected, Tone HARD is selected; the portrait mode, Tone ORG; and the other image-pickup modes, Tone STD.

In addition, in the present embodiment, the signal processing unit is configured of hardware circuits; however, the signal processing unit may be realized by software. Furthermore, the high-sensitivity image data and the low-sensitivity image data may be obtained not only by one-time image pickup through a CCD having main pixels and subordinate pixels, but also by two-time image pickup through a normal imaging element, while changing exposure conditions.

What is claimed is:

1. An image-processing method of synthesizing an high-sensitivity image having a narrow dynamic range and an low-sensitivity image having a wide dynamic range to create an image having a wide dynamic range, the image-processing method comprising:
a first gradation-conversion step of applying a gradation conversion to each of a high-sensitivity image signal representing the high-sensitivity image and a low-sensitivity image signal representing the low-sensitivity image;
an addition step of adding the gradation-converted high-sensitivity image signal and the gradation-converted low-sensitivity image signal; and
a second gradation-conversion step of further applying a gradation conversion, to the added image signal, that corresponds to a gradation property selected from a plurality of gradation properties.

2. The image-processing method according to claim 1, wherein the first gradation-conversion step implements a gradation conversion that varies in accordance with width of a dynamic range.

3. The image-processing method according to claim 1, wherein the second gradation-conversion step implements a gradation conversion for changing a tone of an image represented by the added image signal into one of tones over a range from soft tone to hard tone, that corresponds to a gradation property, among a plurality of gradation properties, selected in accordance with an image-pickup mode.

4. The image-processing method according to claim 2, wherein the second gradation-conversion step implements a gradation conversion, for changing a tone of an image represented by the added image signal into one of tones over a range from soft tone to hard tone, that corresponds to a gradation property, among a plurality of gradation properties, selected in accordance with an image-pickup mode.

5. An image-processing device for synthesizing a high-sensitivity image having a narrow dynamic range and an low-sensitivity image having a wide dynamic range to create an image having a wide dynamic range, the image-processing device comprising:
a first gradation-conversion device that applies a gradation conversion to a high-sensitivity image signal representing the high-sensitivity image;
a second gradation-conversion device that applies a gradation conversion to a low-sensitivity image signal representing the low-sensitivity image;
an addition device that adds the high-sensitivity image signal and the low-sensitivity image signal that have been gradation-converted by the first gradation-conversion device and the second gradation-conversion device, respectively; and
a third gradation-conversion device that applies a gradation conversion, to the added image signal, that corresponds to a gradation property selected from a plurality of gradation properties.

6. The image-processing device according to claim 5, wherein the first gradation-conversion device and the second gradation-conversion device each have a plurality of gradation-conversion look-up tables each corresponding to width of a dynamic range, and apply respective gradation conversions to the high-sensitivity image signal and the low-sensitivity image signal, based on respective gradation-conversion look-up tables selected from the plurality of gradation-conversion look-up tables.

7. The image-processing device according to claim 5, wherein the third gradation-conversion device has a plurality of gradation-conversion look-up tables for converting a tone of an image represented by the added image signal into a plurality of tones within a range from soft tone to hard tone, and applies a gradation conversion to the added image signal, based on a gradation-conversion look-up table selected from the plurality of gradation-conversion look-up tables.

8. The image-processing device according to claim 6, wherein the third gradation-conversion device has a plurality of gradation-conversion look-up tables for converting a tone of an image represented by the added image signal into a plurality of tones within a range from soft tone to hard tone, and applies a gradation conversion to the added image signal, based on a gradation-conversion look-up table selected from the plurality of gradation-conversion look-up tables.

9. An imaging device comprising:
an image-pickup device that can pick up each of a high-sensitivity image signal and a low-sensitivity image signal;
a first gradation-conversion device that applies a gradation conversion to a high-sensitivity image signal picked up through the image-pickup device;
a second gradation-conversion device that applies a gradation conversion to a low-sensitivity image signal picked up through the image-pickup device;
an addition device that adds the high-sensitivity image signal and the low-sensitivity image signal that have been gradation-converted by the first gradation-conversion device and the second gradation-conversion device, respectively;
a third gradation-conversion device that applies a gradation conversion, to the added image signal, that corresponds to a gradation property selected from a plurality of gradation properties;
an image-pickup mode selection device that selects an image-pickup mode; and
a controlling device that makes a gradation property to be selected based on an image-pickup mode that has been selected by the image-pickup mode selection device, the gradation property being utilized in the third gradation-conversion device.

10. The imaging device according to claim 9, wherein the first gradation-conversion device and the second gradation-conversion device each have a plurality of gradation-conversion look-up tables each corresponding to width of a dynamic range, and apply respective gradation conversions to the high-sensitivity image signal and the low-sensitivity image signal, based on respective gradation-conversion look-up tables selected from the plurality of gradation-conversion look-up tables.

11. The imaging device according to claim 9, wherein the third gradation-conversion device applies a gradation conversion to the added image signal, based on a gradation-conversion look-up table selected from a plurality of gradation-conversion look-up tables for converting a tone of an image represented by the added image signal into a plurality of tones within a range from soft tone to hard tone.

12. The imaging device according to claim 10, wherein the third gradation-conversion device applies a gradation conversion to the added image signal, based on a gradation-conversion look-up table selected from a plurality of gradation-conversion look-up tables for converting a tone of an image represented by the added image signal into a plurality of tones within a range from soft tone to hard tone.
